(19) United States
(12) Patent Application Publication
(10) Pub. No.: US 2023/0331080 A1
(43) Pub. Date: Oct. 19, 2023

(54) OPENING DEVICE FOR A MOTOR VEHICLE DOOR ELEMENT

(71) Applicant: KIEKERT AKTIENGESELLSCHAFT, Heiligenhaus (DE)

(72) Inventor: Marco EGGERT, Düsseldorf (DE)

(21) Appl. No.: 18/042,616

(22) PCT Filed: Jul. 13, 2021
(86) PCT No.: PCT/DE2021/100612

§ 371 Date: Mar. 9, 2023

(30) Foreign Application Priority Data
Sep. 10, 2020 (DE) 10 2020 123 596.8

(51) Int. Cl. B60K 15/05; E05B 81/80

(52) U.S. Cl. CPC B60K 15/05; E05B 81/80; B60K 2015/0538; B60K 2015/0569

(57) ABSTRACT

An opening device for a motor vehicle door element, more particularly a side door, comprising an electrically actuatable door lock, an electrical drive unit, a setting means and a control unit, wherein an operating mode can be selected by means of the control unit, and wherein a means for emergency power supply is provided at the opening device.

The invention relates to an opening device for a motor vehicle door element—in particular, a side door—having an electrically-actuatable door lock, an electric drive unit, a setting means, and a control unit, wherein an operating mode can be selected by means of the control unit.

Today's motor vehicles are increasingly being provided with convenience functions. For example, in order to facilitate getting into a motor vehicle and to be able to influence the aesthetic and aerodynamic shape of a motor vehicle, motor vehicles are equipped, for example, without an outer door handle. It is also conceivable, however, that an outside door handle be provided, but that this only forward a switching signal to the motor vehicle door lock for opening. In order to facilitate and automate getting into vehicles and to allow getting into vehicles without outer door handles, so-called opening devices or door openers are used, some of which are also referred to as door checkers.

DE 10 2017 129 527 A1 discloses a method and a device for detecting a user action on a door of a motor vehicle. The door is assigned an actuator for holding the door, which is configured to detect a position of the door relative to the motor vehicle, wherein the method for detecting the user interaction comprises at least the steps of “holding the door” relative to the motor vehicle by the actuator in a holding position, checking whether, from the holding position, a user interaction consisting in a change in the position of the door has taken place within a predefined time unit, which change is greater or equal to a predefined threshold value and, if the answer is affirmative, releasing the door by the actuator.

DE 10 2019 126 590 A1 discloses a method for controlling a mechatronic system for opening, holding, or pulling shut a door element, which is arranged pivotably on a motor vehicle, with the method steps of activating the system, checking a user condition, selecting an operating mode, querying a deactivation of the system, and querying whether a termination condition is fulfilled. The known method describes the sequence and the states or operating modes during the opening of the door element. In particular, it is checked in each query cycle whether a termination condition is present, so that an opening of the door element can be interrupted or terminated.

The known systems for opening a door element are integrated into the on-board network of the motor vehicle and are supplied with voltage and controlled or regulated via the on-board power supply system. In this case, it can be problematic that, in the event of a failure of the voltage supply, an automatic opening is no longer possible. This can, in particular, be associated with a disadvantage, or even the risk, that, in the case of handle-less doors, a manual opening of the door element is no longer possible. This is where the invention comes in.

Proceeding from the known state of the art, the object is to provide an improved opening device. In particular, the object is to provide an opening device for a motor vehicle door element which, even in extreme situations, such as a voltage drop or a voltage failure, allows the opening of the door element. In addition, the object is to provide a method by means of which a handle-less door element enables the door element to be opened even in the event of a power drop or power failure.

The object is achieved by the features of the independent claim 1. In terms of process technology, the object of the invention is achieved by a method according to claim 10. Advantageous forms of the invention are given in the subclaims. It should be noted that the exemplary embodiments described below are not restrictive; rather, any options for variation of the features described in the description and the dependent claims and the drawings are possible.

The object of the invention is achieved, in terms of process technology, in that an opening device for a motor vehicle door element, and in particular a side door, is provided, having an electrically-actuatable door lock, an electric drive unit, a setting means, and a control unit, wherein an operating mode can be selected by means of the control unit, and wherein a means for emergency power supply is provided at the opening device. The design of the opening device according to the invention makes it possible to open the motor vehicle door element even in the event of a voltage drop or a voltage failure. In this case, the means for emergency power supply makes it possible for the opening device to be actuatable even if voltage or power supply can no longer be ensured by the motor vehicle. Such a state can occur in the motor vehicle, for example, when the vehicle has stood for a long period of time, the power supply has failed due to incorrect operation, and/or power is no longer available due to an accident. In all these cases, the user of the motor vehicle must be able to open the motor vehicle or the door element. By integrating an emergency power supply into the opening device, it is possible to activate and operate the opening device independently of the motor vehicle.

The motor vehicle door element is preferably a side door of a motor vehicle which can be transferred from a closed position into an open position by means of the opening device. However, it is also conceivable that the motor vehicle door element be a rear door on a motor vehicle or a utility vehicle. By means of the opening device, a door element can be slightly opened so that the user can grasp and completely open the door element. Typically, adjustment movements of approximately 100 mm, preferably 60 mm, and even more preferably 45 mm, are provided. As already stated above, the opening device is not limited to a motor vehicle door element, but can also be used wherever pivotably-arranged components on the motor vehicle are to be provided to or opened by the user. These components can also be a cover or a closed compartment, for example.

The opening device has an electrically-actuatable door lock or interacts with an electrically-actuatable door lock. Different embodiments of the opening device are conceivable according to the invention. On the one hand, the opening device can be integrated into the electrically-actuatable door lock, and, on the other, the opening device can also simply be connected to the door lock. However, it is also conceivable that the door lock and the opening device be arranged as separate components at different positions in the motor vehicle. An electrically-actuatable door lock is characterized in that a locking mechanism consisting of a catch and at least one pawl is present in the door lock, which pawl can be latched into one or two latching positions. In this case, the pawl can hold the rotary latch in the latching position, and an electrical drive—preferably a DC motor—can move the pawl out of engagement with the rotary latch indirectly or directly. The electrically-actuatable door lock is essential in this case, since only one command or signal, with which the opening device is activated, is provided by the user, so as to increase the comfort of operation of the motor vehicle. If the user outputs a signal, e.g., via a scanning sensor or a wireless remote control, the electrically-actuatable lock is first unlocked, so that the door element is released. Immediately thereafter or parallel thereto, the opening device receives a signal to actuate a setting means, so that the door element released by the door lock can be pivoted or adjusted and opened.

The opening device further has an electric drive unit and a setting means. The electric drive unit is designed to actuate the setting means. By means of the electric drive unit, the setting means is preferably moved out of an opening of a vehicle body, so that the setting means is able to initiate a setting movement in the door element. In this case, linear and rotational movements of the setting means are conceivable.

The electrical control unit can be arranged as a separate component in the opening device, but it is also conceivable and advantageous for cost reasons to use the control inherent in the motor vehicle to control the opening device. On the one hand, the control can select the operating mode, and, on the other, it can activate the means for emergency power supply, so that an actuation of the opening device and/or of the door lock can be enabled by means of the emergency power supply.

If the emergency power supply is designed as an externally-accessible power supply, a variant embodiment of the invention results. The design of the means for emergency power supply as an externally-accessible power supply offers the advantage that the opening device can be actuated independently of the motor vehicle. In particular, the door lock can be electrically actuatable on the one hand by the external power supply and, on the other, an opening can take place by means of the setting means. In this case, the emergency power supply means can act either directly on the door lock and the drive unit, or it is also conceivable for the emergency power supply to supply the control unit with an emergency power, so that the opening device can be operated by the control unit.

It can also be advantageous if external access can be arranged in the region of a flap, and preferably a fuel filler flap and/or a charging socket. As a means for supplying power, in this embodiment variant, the opening device has an external access which can also be arranged at a distance from the opening device inside the motor vehicle. For example, the external access can be arranged in the region of a flap or behind a cover. It is also conceivable that the external access be able to be arranged, for example, in the region of a door handle, wherein, for example, the external access is accessible by pulling on the door handle. The external access then makes it possible to connect the emergency power supply to the opening device. The external access can be designed in different forms and can be designed, for example, as a standardized standard connector, such as a USB plug. As a power supply, conventional rechargeable batteries, normal batteries, or also an external voltage source such as a household power supply are conceivable, to cite only a few examples. It is of course also conceivable to use conventional devices such as a battery charger or a starter device.

If the emergency power supply can be coupled to the opening device by means of the control unit, an advantageous embodiment variant of the invention results. The connection between the emergency power supply and the control unit has the advantage that the control programs or control commands implemented in the control unit can be used to control the opening device. In other words, the emergency power supply must provide only the power supply, whereas the control unit performs the control of the door lock and of the electric drive unit.

In a particularly advantageous manner, a legitimization of the emergency power supply can be carried out by means of the control unit. The emergency power supply, and in particular the configuration of an external access as an emergency power supply, enables the user to connect a power supply to the opening device. Now, in order to prevent theft, for example, the emergency power supply must be legitimized. According to the invention, a legitimization takes place via the control unit. If the control unit detects, for example, a voltage drop and a predeterminable threshold value of the voltage drop, a legitimization of the external emergency power supply can take place as a result of the voltage drop. This means that, in the event of a voltage drop, if the control detects the threshold value, in which the power supply inherent to the motor vehicle reaches a value at which the opening device can no longer be operated, the means for emergency power supply is activated so that an external voltage supply of the opening device is possible. The same applies in the event that the control unit detects a voltage failure. The detection of the voltage failure can be accompanied by a legitimization of the external emergency power supply.

It is also conceivable according to the invention that the legitimization be able to be carried out by means of an external control device, and preferably a smartphone, a smart device, a key fob, and/or an NFC card. In this case, the external control device accesses the opening device and simultaneously enables the voltage supply and the legitimization. Thus, a legitimization can take place by the external device and via the external access. It is thus ensured also that only the user who is authorized to use the motor vehicle actually actuates the opening device and opens the door element.

Furthermore, it can be advantageous according to the invention if the legitimization can be carried out by means of a crash signal. If, for example, an accident occurs, it may happen that the vehicle is disconnected from the internal voltage supply. If the crash signal is now used to activate a legitimization of the external access or of the means for emergency power supply, it is also possible in the event of an accident to actuate the opening device by means of the emergency power supply and, consequently, to open the door element.

Another possibility for a legitimization and thus activation of the emergency power supply means is to actuate a circuit breaker. The circuit breaker can, for example, be activated via a radio remote control or via the control unit in the event of a current drop. After the activation of the circuit breaker, a legitimization can then take place via the circuit breaker itself, so that the door element can be opened by means of the opening device. In any case, the opening device according to the invention makes it possible to open the door in the event of a voltage drop or voltage failure and to allow the motor vehicle to be opened—for example, in the case of a handle-free door.

In terms of process technology, the object of the invention is achieved by providing a method for opening a motor vehicle door element—in particular, a door element without an external door handle—in which, in the event of a power drop or a power failure, an emergency power supply for an opening device according to one of the preceding claims is provided, in which a means for emergency power supply is activated only as a result of a legitimization. The method according to the invention makes it possible to ensure that only an authorized user can perform an opening of the door element. In particular, the legitimization can ensure that no unauthorized opening of the motor vehicle door element takes place. Only the legitimization step of the method activates the emergency power supply means and makes it available to the user. If a current drop is detected by a control unit in the motor vehicle, a legitimization is performed. According to the invention, however, it is also conceivable that the legitimization process be carried out via an external control unit. A crash signal can also carry out the legitimization step, and the legitimization can also take place by activation of a circuit breaker. In any case, it is ensured that, in the method according to the invention, an actuation of the opening device is allowed only after legitimization has taken place.

The invention is explained in more detail below with reference to the attached drawings on the basis of a preferred exemplary embodiment. However, the principle applies that the exemplary embodiment does not limit the invention, but is merely an advantageous embodiment. The features shown can be implemented individually or in combination with further features of the description as well as the claims.

In the drawings:

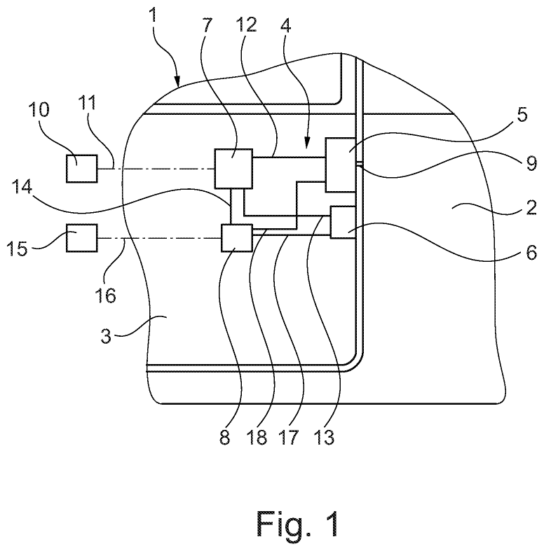

FIG. 1 shows a basic representation of an opening device with a means for emergency power supply as an integral component of a motor vehicle and in a basic arrangement in a motor vehicle, wherein a side view of a motor vehicle door element in a motor vehicle is shown.

FIG. 1 shows a side view of a motor vehicle 1 in the region of a side wall 2 and a door element 3. An opening device 4 is shown in a basic form with reference to the position in the door element 3.

The opening device 4 has an electrically-actuatable door lock 5, a drive unit 6 with a setting means, a control unit 7, and an externally-accessible power supply 8. By means of the door lock 5, the door element 3 can hold the door element 3 in a closed position, in cooperation with a lock holder 9. If, for example, a control signal 11 is then forwarded to the control unit 7 by means of a radio remote control 10, the electrically-actuatable door lock 5 can be unlocked via a control line 12, as a result of which a locking mechanism located in the interior of the door lock 5 releases the lock holder 9. The door element 3—in this case, a side door 3 of a motor vehicle 1—is now held freely pivotable in the motor vehicle 1. The door element 3 can now be transferred to an open position by means of the drive unit 6 and the setting means located in the drive unit 6. For this purpose, the drive unit 6 is controlled, simultaneously with or after the unlocking of the locking mechanism, via a control line 13.

If a voltage drop now occurs in the motor vehicle 1, this voltage drop can be detected by the control unit 7 of the motor vehicle 1. The externally-accessible power supply, e.g., in the form of a socket, can now be enabled via the control line 14. In this exemplary embodiment, the legitimization of the means for emergency power supply 8 takes place via the voltage drop in the motor vehicle 1. If the voltage drop has been detected and the externally-accessible power supply 8 activated, an external voltage source 15 can be connected, via, for example, a cable connection 16, to the socket 8 of the motor vehicle 1. The external power supply 8 is now able either to supply the control unit 7 with a voltage via the control line 14, so that the door lock 5 and the drive unit 6 can be supplied with a voltage, or to supply a current via the control lines 12, 13, or the power supply 8 itself conducts a corresponding voltage to the door lock 5 or the drive unit 6 via separate control lines 17, 18. The direct control of the door lock 5 and the drive unit 6 via the control lines 17, 18 can take place, for example, when the external voltage source itself has its own control unit, wherein the external voltage source is, for example, a smartphone with appropriate software.

It is also conceivable according to the invention that a legitimization be carried out, via a crash signal, in the control unit 7. The socket 8, which can be arranged, for example, behind a flap of a charging socket, is then activated, so that a voltage source 15 can supply the opening device 4 with a voltage or a current. However, the legitimization can also take place via a smartphone 10, wherein the smartphone 10 in turn sends a control signal to the control unit 7, so that the control unit 7 enables the external power supply via the socket 8. In any case, it is ensured that, in the event of a voltage drop, the opening device 4 can be activated and operated via the externally-accessible power supply 8.

### LIST OF REFERENCE SIGNS

1 motor vehicle
2 side wall
3 door element
4 opening device
5 door lock
6 drive unit
7 control unit
8 externally-accessible power supply, socket
9 lock holder
10 radio remote control, smartphone
11 radio signal
12, 13, 14, 17, 18 control line
15 voltage source
16 cable connection

1. An opening device for a motor vehicle door element comprising:
an electrically-actuatable door lock that holds the vehicle door element in a locking position and releases the vehicle door element to an open position, an electrical drive unit that is actuated for setting the vehicle door element between the locking position and the open position, and a control unit that operates the electric drive unit, wherein an operating mode is selected by the control unit, and
an emergency power supply that supplies power at to the control unit for operating the opening device.

2. The opening device according to claim 1, wherein the emergency power supply is configured as an externally-accessible power supply that is connectable to the control unit.

3. The opening device according to claim 1, further comprising an external access for connecting the emergency power supply and a flap, wherein the external access is arranged in a region of the flap for connection of the emergency power supply.

4. The opening device according to claim 1, wherein the emergency power supply is coupled to the opening device by the control unit.

5. The opening device according to claim 1, wherein the emergency power supply is legitimized by the control unit for authorizing the emergency power supply to supply power for operating the opening device.

6. The opening device according to claim 5, wherein the legitimization is carried out in response to a voltage drop.

7. The opening device according to claim 5, wherein the legitimization is carried out by the control unit, the control unit being configured as an external control unit.

8. The opening device according to claim 5, wherein the legitimization is carried out in response to a crash signal.

9. The opening device according to claim 5, wherein the legitimization is carried out in response to activation of a circuit breaker.

10. A method for opening a motor vehicle door element comprising the steps of:
sensing a current drop, determining a legitimization decision for an emergency power supply for an opening device according to claim 1 in response to the current drop, and activating the emergency power supply when the legitimization determination results in a legitimization.

11. The opening device according to claim 3, wherein the flap is a fuel filler flap or a charging socket.

12. The opening device according to claim 7, wherein the external control unit is a smartphone, a smart device, a key fob, and/or an NFC card.

13. The method according to claim 10, wherein the legitimization is carried out in response to a crash signal.

14. The method according to claim 10, wherein the legitimization is carried out in response to activation of a circuit breaker.
